(19) United States
(12) Patent Application Publication
(10) Pub. No.: US 2015/0055158 A1
(43) Pub. Date: Feb. 26, 2015

(54) PROCESSING APPARATUS

(71) Applicant: FUJI XEROX CO., LTD., Tokyo (JP)

(72) Inventors: Kenta OGATA, Kanagawa (JP); Osamu GOTO, Kanagawa (JP)

(73) Assignee: FUJI XEROX CO., LTD., Tokyo (JP)

(21) Appl. No.: 14/204,650

(22) Filed: Mar. 11, 2014

(30) Foreign Application Priority Data
Aug. 23, 2013 (JP) 2013-173073

(51) Int. Cl. H04N 1/00

(52) U.S. Cl. CPC H04N 1/00891; H04N 2201/0094; H04N 2201/0084
USPC 358/1.13

(57) ABSTRACT

Provided is a processing apparatus that receives an operation and performs a process in response to the operation, the processing apparatus including a camera that captures an image of a human approaching the processing apparatus, and a control unit that analyzes a distance to a human within an angle of the view of image capturing and a travelling direction of the human, based on the captured image generated by the camera, using analysis results as one basis determines whether to cause the processing apparatus to transition to an enabled state, and causes the processing apparatus to transition to an enabled state when the determination of the transition to an enabled state is made.

### CROSS-REFERENCE TO RELATED APPLICATIONS

This application is based on and claims priority under 35 USC 119 from Japanese Patent Application No. 2013-173073 filed Aug. 23, 2013.

### BACKGROUND

(i) Technical Field

The present invention relates to a processing apparatus.

(ii) Related Art

There are known various processing apparatuses such as an image forming apparatus processing an image to form the image on a sheet or a facsimile machine reading an image on an original document to perform facsimile transmission.

### SUMMARY

According to an aspect of the invention, there is provided a processing apparatus that receives an operation and performs a process in response to the operation, the processing apparatus including:

a camera that captures an image of a human approaching the processing apparatus; and

a control unit that analyzes a distance to a human within an angle of the view of image capturing and a travelling direction of the human, based on the captured image generated by the camera, using analysis results as one basis determines whether to cause the processing apparatus to transition to an enabled state, and causes the processing apparatus to transition to an enabled state when the determination of the transition to an enabled state is made,

wherein the camera has an elevation angle that keeps a head of a human approaching an operation distance who operates the processing apparatus within the angle of the view of image capturing and that keeps external light from above the head out of the angle of the view of image capturing.

### BRIEF DESCRIPTION OF THE DRAWINGS

Exemplary embodiments of the present invention will be described in detail based on the following figures, wherein:

FIGS. 1A and 1B are diagrams illustrating a contour of a multifunction machine which is an exemplary embodiment of a processing apparatus according to the present invention;

FIG. 2 is a functional block diagram of the multifunction machine illustrated in FIGS. 1A and 1B;

FIG. 3 is a block diagram illustrating an internal structure of a main controller;

FIG. 4 is a flowchart illustrating a summary of a process in the main controller;

FIG. 5 is an explanatory diagram of an image extraction process in a first camera;

FIGS. 6A and 6B are explanatory diagrams of a process of calculating a moving direction of a human;

FIG. 7 is a block diagram illustrating an internal structure of a second camera image arithmetic operation unit shown as one block in FIG. 3;

FIG. 8 is a diagram illustrating an angle of a view of image capturing of the first camera in a vertical direction;

FIG. 9 is a diagram illustrating a height at which an image of the top of a human is captured in an upper edge of the angle of the view of image capturing, with respect to an elevation angle; and

FIG. 10 is a diagram illustrating whether external light from above the head of a human is incident on the first camera, with respect to a height and an elevation angle.

### DETAILED DESCRIPTION

Hereinafter, an exemplary embodiment of the present invention will be described.

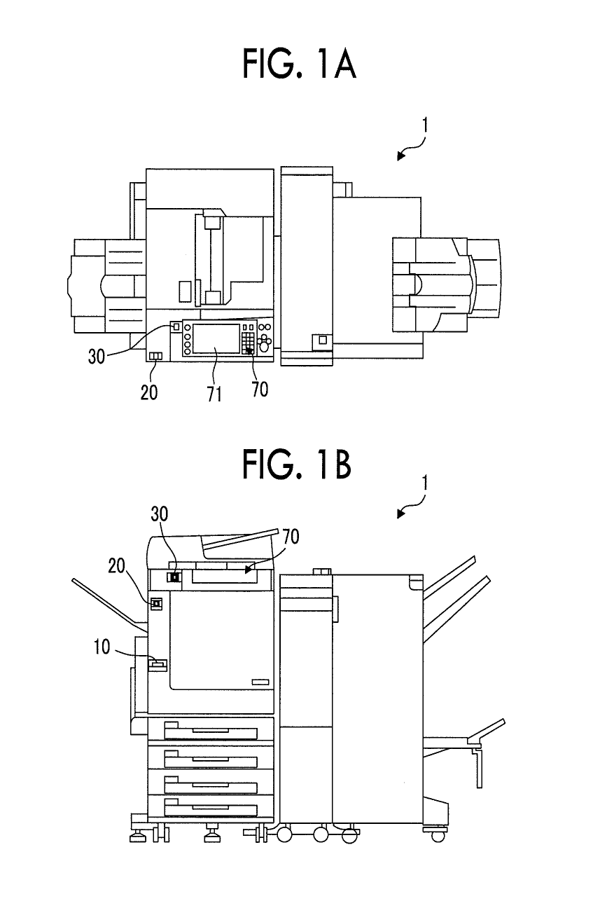

FIGS. 1A and 1B are diagrams illustrating a contour of a multifunction machine which is an exemplary embodiment of a processing apparatus according to the present invention. FIG. 1A is a plan view, and FIG. 1B is a front view.

A multifunction machine 1 includes a pyroelectric sensor 10, a first camera 20, and a second camera 30.

The pyroelectric sensor 10 is a sensor that detects infrared rays by a pyroelectric effect. Herein, approach of a human to the multifunction machine 1 is detected by the pyroelectric sensor 10.

The first camera 20 corresponds to an example of a camera described in the present invention.

The first camera 20 is a camera that captures an image of the front of the multifunction machine 1, and includes a fisheye lens, and thus has a wide angle of a view of image capturing. A distance to a human in the vicinity of the multifunction machine 1 and a moving direction of the human are detected, based on image data which is obtained by image capturing using the first camera 20. Specifically, the human is recognized from above the captured image, and the human's foot (a portion of a foot or shoe) is extracted, and thus the distance to the human is measured by the position of the foot within the angle of the view of image capturing, and the moving direction is detected by a direction of a toe or a time-series movement of the foot. The distance to the human and the moving direction of the human are detected, and thus it is determined whether the human merely passes in the vicinity of the multifunction machine 1 or attempts to use the multifunction machine 1.

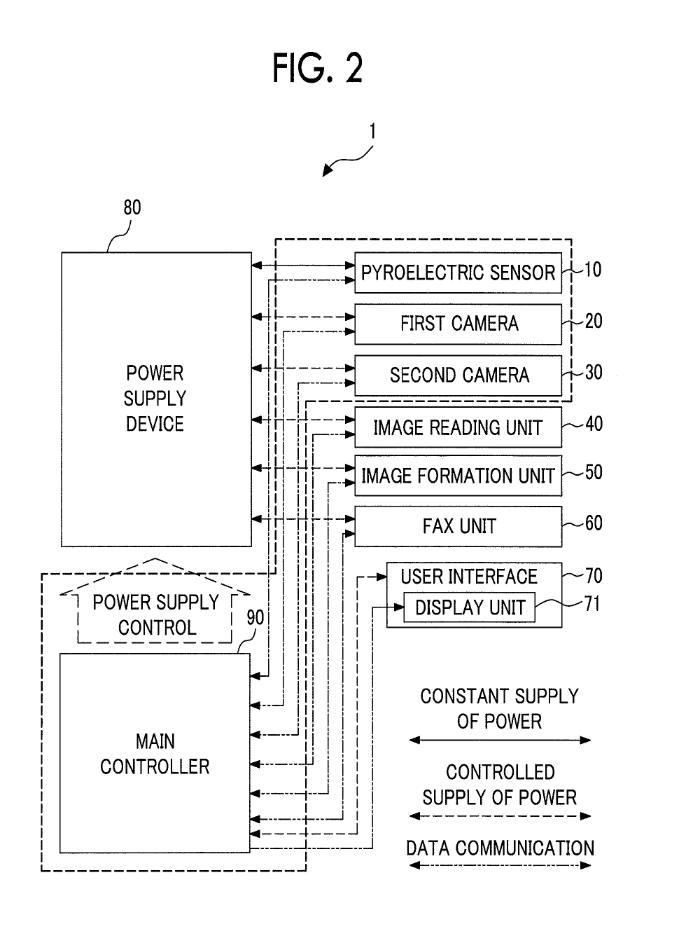

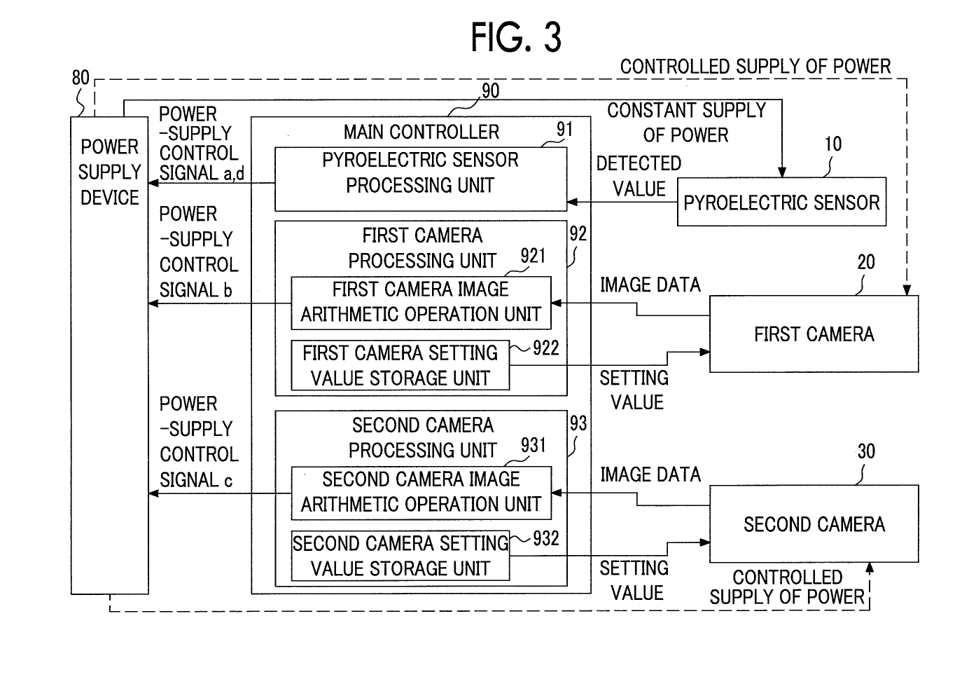

In the multifunction machine 1, the distance to the human within the angle of a view of image capturing and the moving direction of the human are analyzed based on the captured image generated by the first camera 20 in a main controller 90 (see FIG. 2 and FIG. 3) which is to be described later, and as one of the analysis results, it is determined whether to cause the multifunction machine 1 to transition to an enabled state. When the determination of the transition to an enabled state is made, a control of causing the multifunction machine to transition to an enabled state is performed. The details thereof will be described later.

The second camera 30 is a camera facing a forward and obliquely upward direction of the multifunction machine 1. It is determined whether a human in the vicinity of a distance (an operation distance, for example, 350 mm) which is suitable for the operation of the multifunction machine 1 is a human authorized to use the multifunction machine 1, based on image data obtained by the image capturing using the second camera 30. Based on this function, it is possible to allow only a human having the authority to use the multifunction machine 1 to use the multifunction machine 1.

In addition, FIGS. 1A and 1B illustrate a user interface 70. The user interface 70 includes an operator which is operated by a user of the multifunction machine 1 to take on a role in transmitting a user's instruction to the multifunction machine 1. In addition, the user interface 70 includes a display unit 71. The display unit 71 displays various pieces of information such as a state of the multifunction machine 1 or a message to a user. In addition, the display unit 71 displays a user's face which is captured by the second camera 30. Furthermore, the display unit 71 may also display an image captured by the first camera 20 in accordance with an operation.

FIG. 2 is a functional block diagram illustrating a contour of the multifunction machine illustrated in FIGS. 1A and 1B.

The multifunction machine 1 includes not only the pyroelectric sensor 10, the first camera 20, the second camera 30, and the user interface 70 which are described above with reference to FIGS. 1A and 1B, but also an image reading unit 40, an image formation unit 50, and a FAX unit 60.

The image reading unit 40 has a function of reading an image recorded in an original document to generate image data indicating the image.

In addition, the image formation unit 50 has a function of forming an image based on the image data, on a sheet. An electrophotographic printer is suitable as the image formation unit 50. However, the image formation unit is not required to be an electrophotographic type image formation unit, and may be a type that forms an image on a sheet using other methods, for example, using an inkjet printer. Here, the image formation unit 50 is responsible not only for forming an image based on the image data generated by the image reading unit 40 but also for forming an image based on image data received by the FAX unit 60 which will be described below.

The FAX unit 60 is connected to a telephone line (not shown), and takes on a function of transmitting and receiving a facsimile. In a case of the transmission of the facsimile, the image reading unit 40 reads an original document to generate image data for facsimile transmission, and the image data is transmitted from the FAX unit 60. In addition, in a case of the reception of the facsimile, the FAX unit 60 receives the image data, and an image based on the image data is formed on a sheet by the image formation unit 50.

In addition, the multifunction machine 1 further includes the user interface 70, a power supply device 80, and the main controller 90.

The power supply device 80 is controlled by the main controller 90 to take on a role in supplying power to members from the pyroelectric sensor 10 to the user interface 70, and all components requiring power in the multifunction machine 1.

The main controller 90 performs the control of the entire multifunction machine 1 such as the control of the pyroelectric sensor 10 to the FAX unit 60, the control of a display of the display unit 71 included in the user interface 70, and the control of the power supply device 80. In addition, the main controller 90 is also responsible for data communication with components, from the pyroelectric sensor 10 to the user interface 70, and for various data processing.

FIG. 3 is a block diagram illustrating an internal structure of the main controller. Herein, a portion surrounded by a dotted line in FIG. 2, that is, only blocks with regard to the control of the pyroelectric sensor 10, the first camera 20, and the second camera 30, are illustrated.

Herein, a pyroelectric sensor processing unit 91, a first camera processing unit 92, and a second camera processing unit 93 are shown as components of the main controller 90. The first camera processing unit 92 includes a first camera image arithmetic operation unit 921 and a first camera setting value storage unit 922. In addition, similarly, the second camera processing unit 93 includes a second camera image arithmetic operation unit 931 and a second camera setting value storage unit 932. The first camera 20 and the second camera 30 perform various pieces of image processing on an image signal obtained by image capturing. The first camera setting value storage unit 922 and the second camera setting value storage unit 932 store setting values in advance for regulating processing levels or the like of pieces of image processing which are performed in the first camera 20 and the second camera 30, respectively. The setting values stored in the first camera setting value storage unit 922 and the second camera setting value storage unit 932 are set in the first camera 20 and the second camera 30, respectively, at the start of respective operations of the first camera 20 and the second camera 30. The first camera 20 and the second camera 30 perform image processing based on the setting value which is set at the start of operation, on the image signal obtained by image capturing. The first camera 20 and the second camera 30 perform various types of image processing, and the first camera setting value storage unit 922 and the second camera setting value storage unit 932 store various setting values corresponding to these various types of image processing. These various setting values are set in the first camera 20 and the second camera 30 at the start of respective operations of the first camera 20 and the second camera 30. The first camera setting value storage unit 922 and the second camera setting value storage unit 932 are rewritable storage units, and basically store setting values suitable for the multifunction machine 1 in accordance with an installation environment of the multifunction machine 1 or a user's selection, at the time of the installation of the multifunction machine 1.

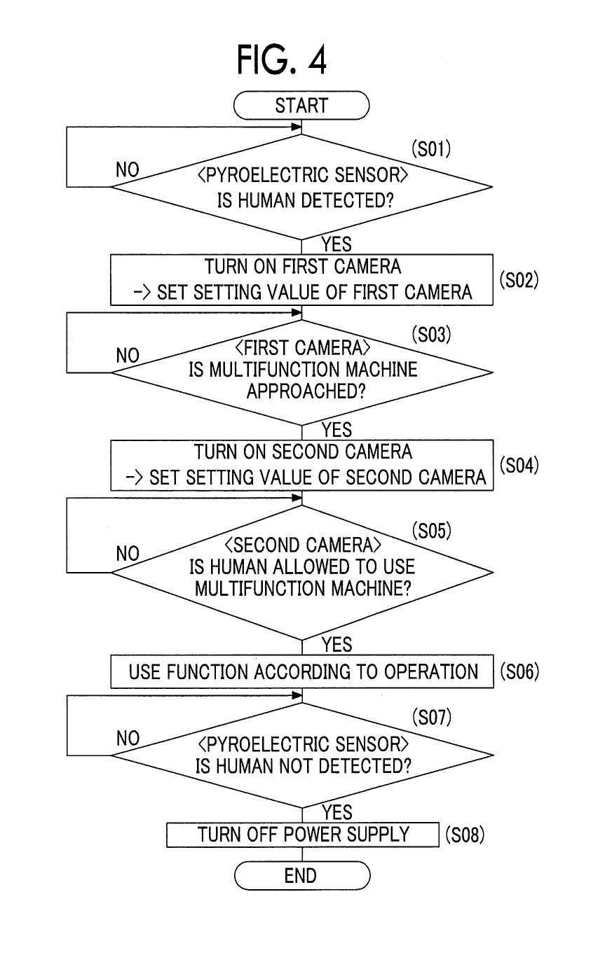

FIG. 4 is a flowchart illustrating a summary of a process in the main controller.

In an initial state, the components from the first camera 20 to the user interface 70 illustrated in FIG. 2 are not supplied with power, and are stopped.

A detected value of the pyroelectric sensor 10 is input to the pyroelectric sensor processing unit 91 of the main controller 90. The pyroelectric sensor processing unit 91 determines whether a human approaches the multifunction machine 1, based on the input detected value (step S01). However, at this time, it is not possible to distinguish whether a human approaches or whether an animal such as a dog or a cat approaches, and it merely determines whether infrared rays are detected by the pyroelectric sensor 10. However, the pyroelectric sensor 10 is for the purpose of detecting approach of a human, and a description will be given below on the assumption that a human approaches.

When the approach of a human to the multifunction machine 1 is detected in the pyroelectric sensor processing unit 91, a power-supply control signal a (see FIG. 3) is transmitted to the power supply device 80. When the power supply device 80 receives a power-supply control signal a indicating that the approach of a human is detected in the pyroelectric sensor 10, the power supply device supplies power to the first camera 20 in turn.

Subsequently, the main controller 90 sets the setting value stored in the first camera setting value storage unit 922 in the first camera 20 (FIG. 4, step S02). Thus, the first camera 20 starts image capturing, and further executes image processing according to the set setting value to generate digital image data.

The image data generated in the first camera 20 is input to the first camera image arithmetic operation unit 921 of the first camera processing unit 92 of the main controller 90. As will be described later, the first camera image arithmetic operation unit 921 recognizes a distance to a human at a position close to the multifunction machine 1 and a moving direction of the human, based on the input image data. Then, in a situation where it is determined that the human attempts to use the multifunction machine 1 (FIG. 4, step S03) in light of the distance to the human and the moving direction of the human, the first camera image arithmetic operation unit 921 outputs a power-supply control signal b to the power supply device 80. When the power supply device 80 receives the power-supply control signal b, the power supply device 80 supplies power to the second camera 30 this time.

Subsequently, the main controller 90 sets the setting value stored in the second camera setting value storage unit 932 in the second camera 30 (FIG. 4, step S04). Thus, the second camera 30 starts image capturing and performs image processing according to the set setting value to generate digital image data. The generated image data is input to the second camera image arithmetic operation unit 931 of the second camera processing unit 93 of the main controller 90. As will be described later, the second camera image arithmetic operation unit 931 determines whether a human located in the vicinity of a substantially operation distance (for example, 350 mm) of the multifunction machine 1 is a human having the authority to use the multifunction machine 1, based on the input image data. Specifically, it is determined whether the human is a human registered in advance as a human having the authority to use the multifunction machine 1 or is anyone else (FIG. 4, step S05). When the second camera image arithmetic operation unit 931 determines that the human is a human having the authority to use the multifunction machine 1, a power-supply control signal c is output from the second camera image arithmetic operation unit 931 to the power supply device 80. When the power supply device 80 receives the power-supply control signal c, the power supply device supplies power, this time, to the image reading unit 40, the image formation unit 50, the FAX unit 60, and the user interface 70, which are illustrated in FIG. 2. Thus, the multifunction machine 1 is set to be in an enabled state, and thus a function based on an operation, for example, a copying function or a FAX function, works (FIG. 4, step S06).

When it is detected that a human is separated from the multifunction machine 1, using the detected value of the pyroelectric sensor 10 (FIG. 4, step S07), a power-supply control signal d indicating the separation of the human is output toward the power supply device 80 from the pyroelectric sensor processing unit 91. Then, the power supply device 80 stops supplying power to the first camera 20 to the user interface 70 except for to the pyroelectric sensor 10 (step S08).

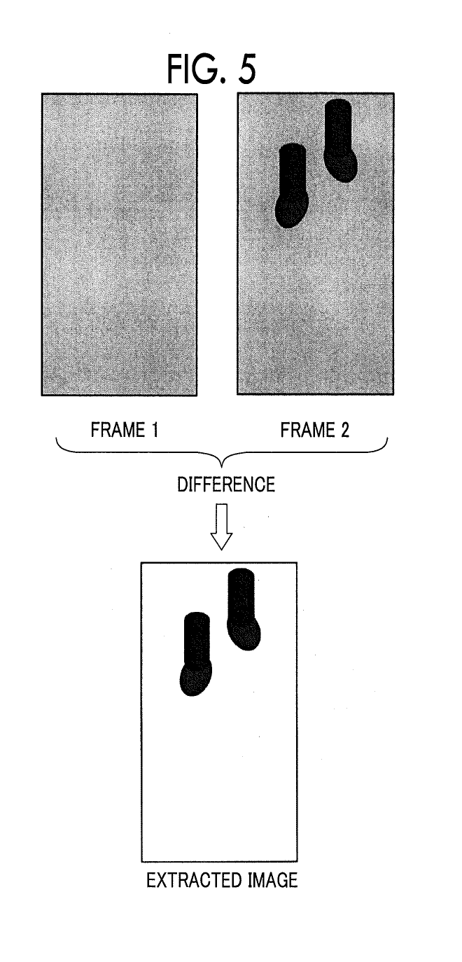

FIG. 5 is an explanatory diagram of an image extraction process in the first camera.

The first camera 20 performs an extraction process on all parts of a human from the head to the foot, but herein, a foot portion which is important for the recognition of a moving direction of the extracted human is illustrated.

Herein, an arithmetic operation of differences between a background image (frame 1) and a human image (frame 2) is performed to extract a human, and thus a foot of the human is extracted from the shape of the extracted human. Then, a distance between the multifunction machine 1 and the human is calculated based on the position of the foot on the extracted image.

Furthermore, the background image may be an image which is captured in advance at the timing when the human is not present within the angle of the view of image capturing of the first camera 20. Alternatively, the background image may be an image in which stationary regions are joined together to be composed, from images of plural frames in which a moving human is captured.

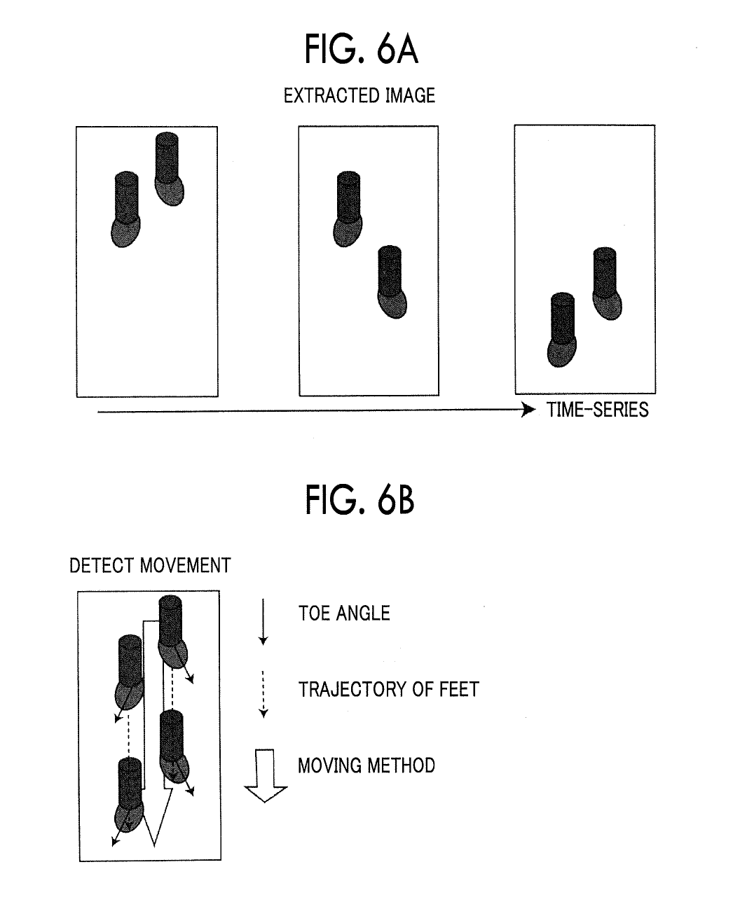

FIGS. 6A and 6B are explanatory diagrams of a process of calculating a moving direction of a human.

FIG. 6A illustrates plural time-series extracted images. All of the plural extracted images are images obtained by the difference arithmetic operation illustrated in FIG. 5.

FIG. 6B is a diagram illustrating the plural extracted images, shown in FIG. 6A, which overlap each other.

FIG. 6B illustrates toe angles and trajectories of feet.

Herein, a moving direction is detected from these toe angles and trajectories of feet. It is determined whether a human attempts to use the multifunction machine 1, based on a distance to the human and a moving direction of the human. When it is determined that an attempt to use the multifunction machine 1 is made, power is in turn supplied to the second camera 30, as described above with reference to FIG. 3 and FIG. 4.

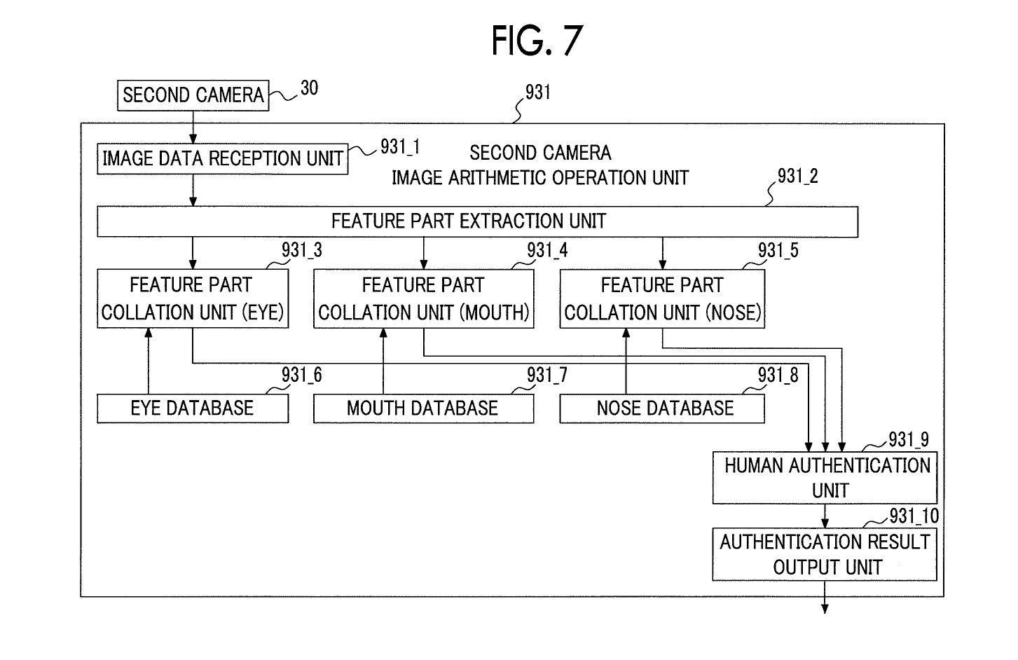

FIG. 7 is a block diagram illustrating an internal structure of the second camera image arithmetic operation unit shown as one block in FIG. 3.

Image data generated by capturing a human's face using the second camera 30 is transmitted to the second camera image arithmetic operation unit 931 within the main controller 90 (see FIG. 3), and is received in an image data reception unit 931_1 of the second camera image arithmetic operation unit 931. The image data received in the image data reception unit 931_1 is input to a feature part extraction unit 931_2. The feature part extraction unit 931_2 extracts feature parts based on the input image data. Herein, specifically, features of the eyes, mouth, and nose of the captured human are extracted. The extraction of the features is a well-known technique, and the detailed description thereof will be omitted here.

In addition, the second camera image arithmetic operation unit 931 includes an eye database 931_6, a mouth database 931_7, and a nose database 931_8. Herein, features of the eyes, mouth, and nose of each human having the authority to use the multifunction machine 1 are registered.

The features of the eyes, the mouth, and the nose which are extracted by the feature part extraction unit 931_2 are input to a feature part collation unit (eye) 931_3, a feature part collation unit (mouth) 931_4, and a feature part collation unit (nose) 931_5, respectively. The feature part collation unit (eye) 931_3, the feature part collation unit (mouth) 931_4, and the feature part collation unit (nose) 931_5 collate the feature data of the eyes, the mouth, and the nose which are input from the feature part extraction unit 931_2 with feature data registered in the eye database 931_6, the mouth database 931_7, and the nose database 931_8 to search for consistent data.

The collation results of the feature part collation unit (eye) 931_3, the feature part collation unit (mouth) 931_4, and the feature part collation unit (nose) 931_5 are transmitted to a human authentication unit 931_9. The human authentication unit 931_9 authenticates whether a human is authorized to use the multifunction machine 1. The authentication results are output from an authentication result output unit 931_10. The authentication results output from the authentication result output unit 931_10 are transmitted as the power-supply control signal c illustrated in FIG. 3 to the power supply device 80. When the authentication results are authentication results indicating that the human is authorized to use the multifunction machine 1, the power supply device 80 starts to supply power to the image reading unit 40 to the user interface 70 which are illustrated in FIG. 2 and brings the multifunction machine 1 into an enabled state.

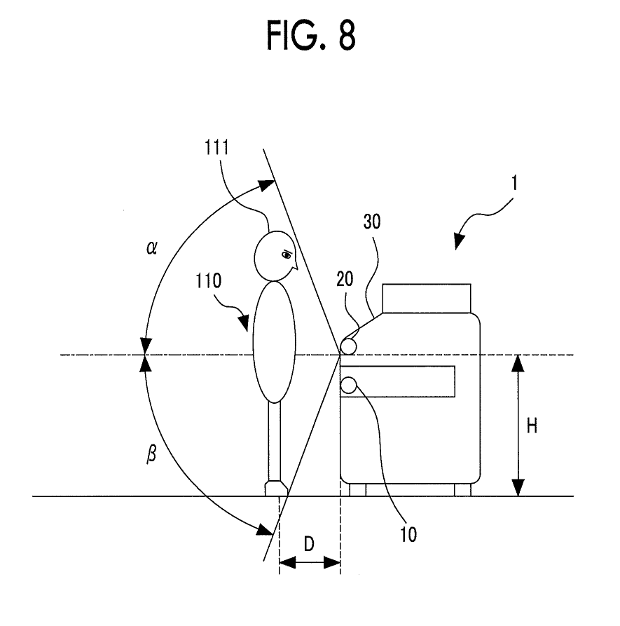

FIG. 8 is a diagram illustrating the angle of a view of image capturing of the first camera in a vertical direction.

The first camera 20 is a camera having an elevation angle α that keeps a head 111 of a human 100 approaching an operation distance D who operates the multifunction machine 1 within the angle of a view of image capturing and that keeps external light from above the head 111 out of the angle of the view of image capturing. Specifically, in this exemplary embodiment, the elevation angle α is set to approximately 70 degrees. In addition, in this exemplary embodiment, a dip angle β is also set to approximately 70 degrees. In order to set such a wide angle, the first camera 20 adopts a fisheye lens (not shown).

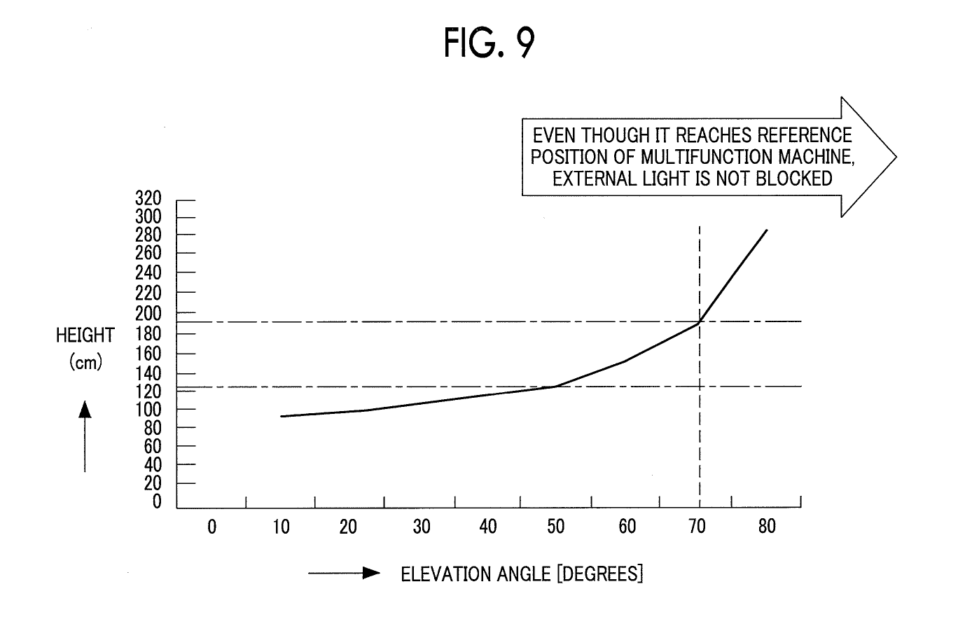

FIG. 9 is a diagram illustrating a height at which an image of the top of a human is captured in an upper edge of the angle of the view of image capturing, with respect to an elevation angle.

Herein, as illustrated in FIG. 8, the first camera 20 is installed at the position of a height H of 874 mm from the floor. In addition, it is assumed that a human stands at the position of an operation distance D of 350 mm which is appropriate for the operation of the multifunction machine 1. Supposing that the elevation angle α of the first camera 20 is set to 10 degrees under these conditions, a graph of FIG. 9 means that the top of a human having a height of approximately 95 cm falls within the angle of the view of image capturing and a portion of the top portion of a human who is taller than this height falls outside the angle of a view of image capturing. Similarly, in a case of a human having a height of 130 cm, the elevation angle α of equal to or greater than 45 degrees makes even the top fall within the angle of the view of image capturing. Furthermore, the elevation angle α of 70 degrees makes even the top of a human having a height of 190 cm fall within the angle of the view of image capturing.

Here, when the maximum height of a human operating the multifunction machine 1 is set to 190 cm, it means that the elevation angle α of 70 degrees leads to sufficient results.

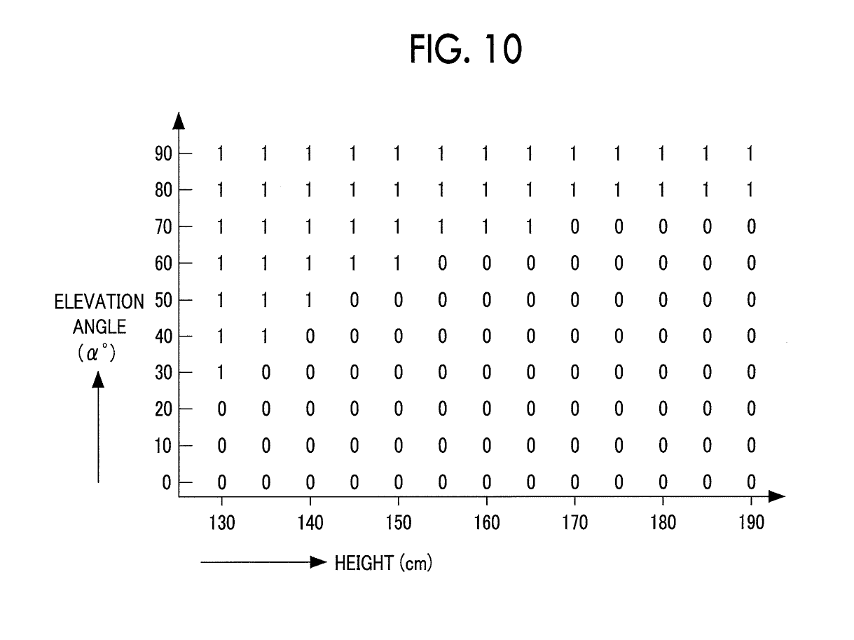

FIG. 10 is a diagram illustrating whether external light from above the head of a human is incident on the first camera, with respect to a height and an elevation angle.

In FIG. 10, “1” means that external light from above the head of a human is incident within the angle of a view of image capturing of the first camera 20, and “0” means deviation from the angle of the view of image capturing.

For example, an installation environment where an electric light is present on a ceiling or sunlight enters from a window is considered as an installation environment of the multifunction machine 1 (see FIGS. 1A and 1B). When such a strong light beam is directly incident on the first camera 20, images of regions which are captured other than the region of the light beam are dark due to a great influence of the light beam, and thus there is a concern that the detection accuracy of the distance to a human and the moving direction of a human, which are described above, may be greatly decreased. Therefore, it is necessary to achieve both making the head of a human fall within the angle of the view of image capturing and blocking of the above-described strong light beam incident over the head of a human.

As seen from FIG. 10, when the elevation angle α of the first camera is set to 80 degrees or 90 degrees, external light falls within the angle of a view of image capturing over the head of a human having a maximum height of 190 cm, who is an operator of the multifunction machine 1.

In this exemplary embodiment, the elevation angle α of the first camera 20 is set to approximately 70 degrees based on this perspective.

In addition, in this exemplary embodiment, the dip angle β is also set to approximately 70 degrees. This is because an image is captured of the foot of a human who stands at the position of an operation distance D of 350 mm by calculation from an installation height H of 874 mm of the first camera 20, and an unnecessary subject located beyond the distance is excluded from the angle of a view of image capturing.

Herein, the multifunction machine having both a copying function and a FAX function has been described. However, the processing apparatus of the present invention is not required to be a multifunction machine, and may be, for example, a copy machine having only a copying function or may be a FAX machine having only a FAX function.

Furthermore, the processing apparatus of the present invention is not limited to a copying function or a FAX function, and may be an apparatus that executes a process according to an operator's operation and is not an apparatus of which the process contents are limited.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing apparatus that receives an operation and performs a process in response to the operation, the processing apparatus comprising:
a camera that captures an image of a human approaching the processing apparatus; and
a control unit that analyzes a distance to a human within an angle of the view of image capturing and a travelling direction of the human, based on the captured image generated by the camera, using analysis results as one basis determines whether to cause the processing apparatus to transition to an enabled state, and causes the processing apparatus to transition to an enabled state when the determination of the transition to an enabled state is made,
wherein the camera has an elevation angle that keeps a head of a human approaching an operation distance who operates the processing apparatus within the angle of the view of image capturing and that keeps external light from above the head out of the angle of the view of image capturing.

2. The processing apparatus according to claim 1,
wherein the camera has the angle of the view of image capturing with an elevation angle of approximately 70 degrees.

3. The processing apparatus according to claim 2,
wherein the camera has the angle of the view of image capturing with a dip angle of approximately 70 degrees.
